(19) United States
(12) Patent Application Publication
(10) Pub. No.: US 2003/0224080 A1
(43) Pub. Date: Dec. 4, 2003

(54) Automated pin for gas assisted injection molding

(76) Inventor: Ronald Thomas, Chesterfield, MI (US)

Correspondence Address: Robert A. Dunn, Dinnin & Dunn, P.C., Ste. 500, 2701 Cambridge Court, Auburn Hills, MI, 48326, US

(21) Appl. No.: 10/411,738

(22) Filed: Apr. 11, 2003

Related U.S. Application Data
(63) Continuation-in-part of application No. 09/553,807, filed on Apr. 21, 2000.

(51) Int. Cl. B29C 45/16

(52) U.S. Cl. 425/130

(57) ABSTRACT

An injection molding apparatus is provided that comprises a molding tool having a mold cavity, a source of pressurized gas, and a nozzle with a reciprocable pin, the pin valving gas injection into the molding cavity. A gas valve is positioned adjacent the nozzle, the gas valve selectively connecting the gas source with the nozzle. A nozzle having a reciprocable member for valving fluid injection in an injection molding apparatus is also provided. The nozzle includes a seal comprising a compressible elastomeric member and a sleeve, the reciprocable member slidable in the sleeve. Compression of the elastomeric member deforms the sleeve, creating a fluid seal with the reciprocable member.

This Application is a Continuation-in-Part of U.S. patent application Ser. No. 09/553,807, Filed Apr. 21, 2000

### TECHNICAL FIELD

The present invention relates generally to pressure assisted injection molding apparatuses and processes, and more particularly to a nozzle for injection of fluid in such an apparatus or process.

### BACKGROUND OF THE INVENTION

Gas assisted injection molding of plastic has long been known in the industry. During gas assisted injection molding, molten plastic is forced into an enclosed mold, and gas is injected into the mold within the plastic material. The gas will raise the internal mold pressure and create an expanding gas pocket which will force the cooling plastic to the extreme recesses of the mold, maximizing the fill-out of the mold surface and reducing the sag of the plastic from the mold surface as the plastic shrinks during cooling, thus producing a better finished surface. In gas injection systems, there are two main methods of delivering gas into the mold cavity. The first is directly injecting the gas into the mold cavity, known as in article, while the second is injecting the gas into a channel leading into the mold, which is known as in-runner. The injection of the gas remotely into the cavity is generally preferred over the channel method.

Some more recent designs incorporate the use of both compressible and incompressible fluids in injection molding processes. Apparatuses and processes are known utilizing a multi-step process in which incompressible fluid is injected prior to injecting a compressible fluid. The incompressible fluid, for instance, water, substantially cools the plastic, lessening the time between molding cycles. In some systems, the injected fluid is actually used to drive molten plastic from the mold to a remote reservoir. In one system in particular, pressurized compressible fluid is injected through a nozzle following the injection of water. The mold is then fluidly connected to a low pressure space such as a reservoir or drain, and the water flows from the mold.

In many designs, the fluid/gas supply is positioned remotely from the mold, and is connected to the mold cavity with a supply passage. During injection of pressurized gas into the mold, a delay can occur while the supply system and mold cavity are pressurized to the desired level. The delay increases cycle time. Because injection molding tends to be a relatively high volume production process, designers are continually searching for ways to increase the number of molded parts that can be manufactured in a certain time.

Fluid is typically injected into the mold through a nozzle with a reciprocable rod for valving the fluid injection. In many such designs, the nozzle has an internal passage connectable to the mold cavity within which the rod reciprocates, and the rod is journaled by a portion of the nozzle housing. A significant challenge to designers has been overcoming the tendency of the nozzle to leak fluid through the housing around the area journaling the pin.

In addition to the foregoing concerns, further design challenges relate to the problems of plastic intrusion into fluid injection nozzles/pins during system operation. Gas or fluid injection nozzles are typically located near the plastic injection nozzle so that the fluid injected can best assist the flow of the plastic material through the mold. This, however, typically subjects the fluid injection nozzles to the flow of molten plastic at its most liquid state and highest pressure, which tends to clog or pack fluid injection nozzles. Further, fluid injection nozzles are often used as gas exhaust outlets, so that any molten material will tend to flow toward and into the outlet during the venting process. Cycle time of the molding process is critical to production cost, so venting before the interior of the part has completely cooled may be desirable, creating the potential for un-cooled material flow toward and into the fluid nozzle. Two approaches have typically been used to inhibit the flow of molten resin into the fluid nozzle: a valved fluid nozzle (e.g. U.S. Pat. No. 5,232,711), or an injection pin with very small orifices, which tend to resist the flow of the molten resin (e.g. U.S. Pat. No. 5,820,889). Another method employed to avoid the clogging of the gas supply passages with molten resin is to delay gas injection until the plastic injection is completed, as described in U.S. Pat. No. 5,295,800. However, this allows the plastic to cool somewhat, which reduces the flowability of the material, and reduces the efficacy and efficiency of the fluid-injection process.

The use of valved gas nozzles adds complexity and expense to the entire system. Because injection molding is a relatively high volume production process, such nozzles are subjected to repeated exposure to molten resin under pressure. A valved nozzle requires a reciprocating motion opposing the intrusion of plastic or overcoming the fluid injection pressure, a motion that requires a relatively large force which may lead to wear and failure of the valve and nozzle components. Since repairing or replacing such reciprocating nozzles or valves is time consuming and expensive in material cost and system down time, it is necessary to have a heavy duty but simple device. Exemplary reciprocating nozzles or pins are shown in U.S. Pat. Nos. 4,740,150; 4,905,901; 5,151,278; 5,164,200; 5,198,238 and 5,464,342.

### SUMMARY OF THE INVENTION

In one aspect, the present invention includes an injection molding apparatus including a molding tool having a molding cavity. A source of pressurized gas is provided and is selectively connected to the mold cavity with a gas valve proximate the mold cavity. A reciprocable rod is provided and valve gas injection into the molding cavity.

In another aspect, the present invention provides a nozzle for an injection molding apparatus that includes a nozzle housing defining a fluid passage and an outlet. A rod extends through the fluid passage and is reciprocable therein to valve the outlet. The invention further provides an annular seal in the housing, the seal comprising a compressible elastomeric member and a resilient sleeve positioned about the rod. Compression of the elastomeric member deforms the sleeve, creating a fluid seal with the rod.

### BRIEF DESCRIPTION OF THE DRAWINGS

FIG. 1 is a schematic illustration of a gas assisted injection molding apparatus in accordance with a preferred embodiment of the present invention;

FIG. 2 is a side view of an injection molding apparatus according to a second preferred embodiment of the present invention.

### DETAILED DESCRIPTION

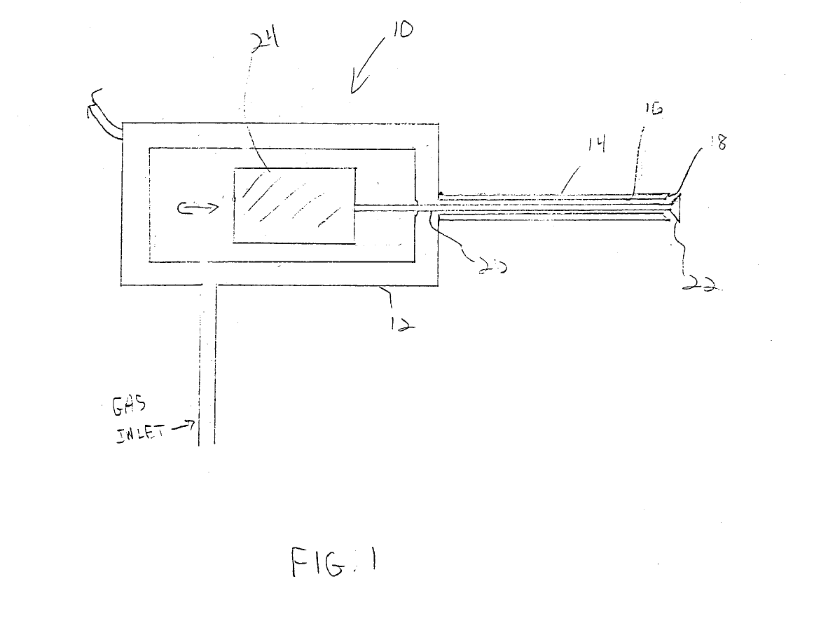

In one aspect, the present invention is a gas injection nozzle pin assembly for a gas assisted plastic injection molding system as shown in the attached FIG. 1. The assembly 10 generally comprises a nozzle having a gas inlet port which communicates with a stored gas which is used to control the metering and flow of the gas into the nozzle. The nozzle includes a generally cylindrical body member 12. Extending from the body member on one end thereof is a pin member 14 containing an elongated cylindrical bore 16. The cylindrical bore has a conical nozzle end 18 which is used to mate with and accept an automatically controlled rod 20. The rod extends along the entire length of the cylindrical bore and into the body member of the nozzle assembly. The rod includes a frustoconical shape 22 on its end such that it mates with the conical nozzle end 18 of the cylindrical bore 16 to create a specific outlet size for gas escaping into the interior of the mold assembly.

The rod is controlled by the use of an electromagnetic solenoid 24 or other type of electronic actuator which will use electrical power to control movement of the rod in and out of the conical nozzle end, based on a sequence of events occurring in the molding operation. The electronic actuator is located within the body of the nozzle assembly and is securely connected to one end of the rod. The electronic actuator is controlled via an electronic control assembly which is attached to the control unit for the gas assisted injection molding assembly. The electronic actuator is activated by introducing current through an electromagnetic coil which is attracted to magnetically conductive metal at an end of the body 12. Additional electromagnetic inserts are preferably located at each end of the body 12 to increase the magnetic attractive forces, and to increase the return force when deactivated. It is preferred to have the device magnetically biased toward the closed position. A coil spring can also be utilized to bias the mechanism toward the closed position.

An alternate embodiment includes a pneumatically controlled actuator for reciprocating the rod. Still another embodiment includes a ball screw drive for driving the rod, which is provided with a threaded end.

The use of the electronically controlled rod will allow the operation of the valve at precise intervals during the plastic injection in the mold such that flow-back does not occur within the cylindrical nozzle bore member. The ease of operation of the electronic pin will also allow for quicker reaction times to an overflow condition that might occur in the nozzle of the cylindrical bore member. Furthermore, the use of the electronically controlled actuating rod will allow for a closed pin while injecting resin and an open large end to pass fluid when cleaning of the nozzle is necessary.

It should be noted that the embodiment disclosed above uses an electronic actuator to control the movement of the rod thus releasing gas during various stages of the gas assisted plastic injection molding operation. It will allow for various amounts of gas to be released depending on the size of the outlet opening created at the nozzle end by actuated movement of the rod in the chamber. It should be noted that any other type of electronic or mechanical switch that can be electronically controlled by the operator or a computer system may be used in controlling the movement of the rod within the nozzle assembly.

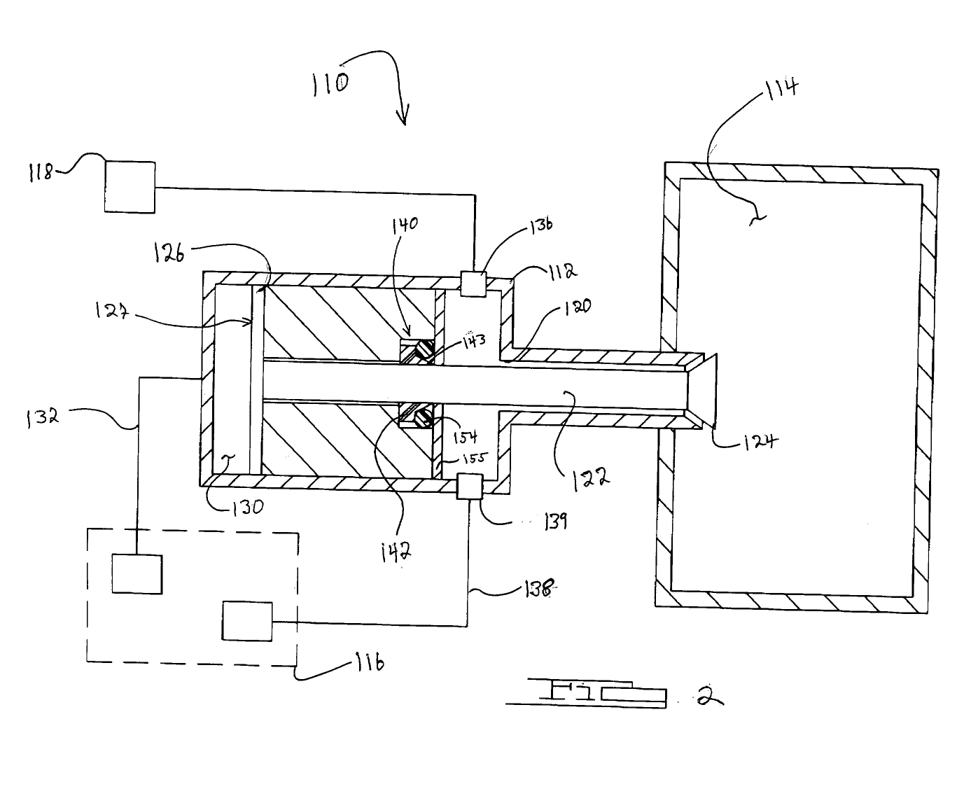

Referring to FIG. 2, there is shown an injection molding apparatus 110 according to a second preferred embodiment of the present invention. Apparatus 110 includes a fluid injection nozzle 112, positioned adjacent and extending into a mold cavity 114. Apparatus 110 further includes a pressurized gas supply 116, which may be two discrete supplies, but is preferably a single supply for the entire system, and a source of incompressible fluid 118. Both source 118 and 116 are fluidly connectable to mold cavity 114 via a fluid passage 120 in nozzle 112. A reciprocable rod 122 is located in nozzle 112, and reciprocates in passage 120, valving fluid communications between passage 120 and mold cavity 114 with an enlarged distal portion 124. Rod 122 preferably includes an enlarged proximal portion 126 that includes a pressure surface 127 exposed to fluid pressure in a chamber 130. A fluid supply line 132 supplies fluid, preferably a compressible fluid, to chamber 130, allowing the axial position of rod 122 to be adjusted by varying the fluid pressure therein. It should be appreciated that any known reciprocation means might be incorporated into apparatus 110 without departing from the scope of the present invention. For instance, rather than using compressible fluid in chamber 130 to reciprocate rod 122, an incompressible fluid such as conventional hydraulic oil might be used. Similarly, an electrical actuator (not shown) could be used to reciprocate rod 122, employing a solenoid and stator apparatus. A biasing spring (not shown) can also be disposed within nozzle 112 to bias rod 122 toward a retracted position, wherein distal portion 124 blocks fluid communications between passage 120 and mold cavity 114.

In a preferred embodiment, nozzle 112 is operable to valve the injection of both compressible and incompressible fluids into cavity 114. Source 118 is connectable to fluid passage 120 via a fluid supply line 134. A first valve 136, for example an electrically actuated valve, is preferably positioned adjacent nozzle 112, and is actuatable to supply fluid, for instance water, to fluid passage 120. Supply 116 is also connectable to fluid passage 120 via a second fluid supply line 138, fluid communications being controlled by a second valve 139. Because the position of rod 122 (controlled with pressure in chamber 130) controls fluid communications between passage 120 and cavity 114, the present invention actually provides two means for controlling delivery of each fluid to cavity 114. As with source 118, the position of rod 122 controls fluid communications between passage 120 and cavity 114, thus controlling at least in part fluid communications between supply 116 and cavity 114. Those skilled in the art will appreciate that fluid pressures are preferably controllable at both supply 116 and source 118, and rod 122 can be extended to open fluid communications with cavity 114 merely by raising the fluid pressure in passage 120 sufficiently, either with fluid from source 118, supply 116, or a combination of both. Increased fluid pressure on enlarged distal portion 124 can force rod 122 to its extended position, allowing fluid to flow into cavity 114. Still further injection styles and sequences are possible with system 110. For instance, a vacuum can be pulled on chamber 130, biasing rod 122 toward a retracted position, while fluid pressure builds in passage 120. When the fluid pressure has increased to the desired level, the vacuum can be relaxed, allowing pressure in passage 120 to drive rod 122 toward an extended position. Because passage 120 is pressurized prior to extending rod 122, in such a process the initial burst of fluid into cavity 114 can take place at maximum pressure, reducing cycle time in many instances. Valve 139, controlling delivery of compressible fluid, is preferably located proximate the mold cavity 114. In a preferred embodiment, valve 139 is positioned directly adjacent the exterior of nozzle 112, however, the valve could be positioned more remotely to nozzle 112 without departing from the scope of the present invention. The positioning of valve 139 adjacent nozzle 112 allows fluid in supply line to be delivered into nozzle 112 in a relatively highly pressurized state. By maintaining valve 139 in a closed state, fluid from source 116 can pressurize the entire supply line 138 upstream of valve 139, reducing the time delay upon opening valve 139 before high pressure fluid is delivered to the mold.

A seal 140 is preferably positioned in nozzle 112, and prevents fluid from leaking along rod 122 past the point where rod 122 extends into fluid passage 120. In a preferred embodiment, seal 140 comprises a deformable sleeve 142 and a compressible elastomeric member 154. Sleeve 142 is preferably formed from polytetrafluoroethylene (TEFLON®) or some other suitable low friction material, and is circumferential of rod 122, having a match clearance therewith, although the interface might be looser without departing from the scope of the present invention so long as the sleeve is sufficiently deformable to make an essentially fluid-tight seal with rod 122. Sleeve 142 preferably has an angular exterior surface 143, against which compressible elastomeric member 154 abuts. Axial compression of member 154, which is preferably an O-ring, causes member 154 to flatten slightly, squeezing inwardly/circumferentially against surface 143. Consequently, sleeve 142 is radially inwardly deformed about rod 122, forming a fluid-tight seal therewith. In the embodiment pictured in FIG. 1, member 154 bears against a plate 155, integral with nozzle 112, allowing axial compression of member 154 by axially urging plate 155 against member 154, or alternatively, urging the components of seal 140 against plate 155. An additional plate or some other type of stop is preferably placed to abut sleeve 142 opposite plate 155, and assists in holding the components of seal 140 in place. Many different means for axially compressing member 154 may be employed. It is merely necessary that sleeve 142 may be securely positioned and member 154 axially compressed, thereby flattening and inwardly deforming sleeve 142.

A typical injection molding cycle according to the present invention begins by injecting a quantity of fluent plastic into mold cavity 114, preferably packing the cavity to as full a state and as great a pressure as possible. At this point, gas pressure in chamber 130 is relatively low and rod 122 is retracted, blocking fluid communications between passage 120 and cavity 114. Valves 136 and 139 are preferably closed. Once the plastic has been introduced into cavity 114, valve 136 is preferably actuated to fluidly connect supply line 134 with fluid passage 120. Close to this time, gas pressure is preferably increased in chamber 130, causing rod 122 to move toward an extended position and fluid, preferably water from source 118, begins to flow past valve 136, and through passage 120 into the mold cavity. The injected water forces still-fluid plastic to the furthest recesses of the mold and forces plastic against the mold surfaces, and cools the plastic in the mold relatively rapidly. In one embodiment, water drives some of the fluent plastic into one or more overspill reservoirs as it is injected. Once a suitable quantity of water has been injected, valve 136 is preferably closed. It should be appreciated that embodiments are contemplated in which rod 122 is not actuated apart from the injected fluid, which acts on enlarged distal portion 124 to extend rod 122 and initiate fluid communications with the mold cavity 114. In a preferred embodiment, a quantity of gas is injected into the mold cavity 114 following injection of water. The mold cavity is packed relatively tightly with water and plastic, and the gas is therefore injected under pressure. The mold cavity is preferably substantially sealed, such that the aforementioned injection of gas creates a relatively small pocket or bubble of pressurized gas, increasing the overall internal mold pressure. After a desired dwell time has elapsed (if any), the mold cavity 114 is preferably fluidly connected to a low pressure space such as a fluid reservoir or drain. Fluid connection of cavity 114 to lower pressure allows the pocket of pressurized to begin to expand, expelling the water from the mold cavity and yielding a hollow molded plastic part.

By locating the gas injection port and its respective valve adjacent the nozzle, the present invention allows a short burst of relatively high-pressure gas to be injected into the mold cavity. In a preferred embodiment, the gas supply line connecting gas supply 116 to valve 139 is pressurized prior to a molding cycle. Thus, when valve 139 is actuated, there is already gas at a pressure suitable for injection proximate the mold. This design contrasts with earlier systems in which a gas valve is actuated remote from the mold, requiring the entire gas supply system from the source to the mold to be pressurized in order to inject create a sufficiently pressurized gas bubble in the water and plastic filled mold cavity. Moreover, the use of separate gas and water ports into nozzle 112 allows pressure to be maintained in the gas line during water injection, in contrast to designs wherein the gas and water are injected via a single nozzle. Thus, rather than a relatively long period of lower pressure gas injection, a relatively short period of higher pressure gas injection can occur. Allowing a relatively small quantity of pressurized gas to be “burped” into the mold in this fashion decreases injection molding cycle time.

The present description is for illustrative purposes only, and should not be construed to narrow the breadth of the present invention in any way. While various preferred embodiments have been disclosed herein, those skilled in the art will appreciate that alterations might be made to many aspects of the presently disclosed embodiments without departing from the scope and spirit of the invention, defined in terms of the claims set forth below. Other aspects, features and advantages will be apparent upon an examination of the attached drawing figures and appended claims.

What is claimed is:

1. An injection molding apparatus comprising:
a molding tool having a mold cavity;
a source of pressurized gas;
a nozzle adjacent said mold cavity, said nozzle defining an interior fluid passage;
a rod reciprocable in said nozzle and valving fluid communications between said fluid passage and said molding cavity;
a gas valve adjacent said nozzle;
wherein said gas valve is actuatable to selectively connect said source of pressurized gas with the interior fluid passage of said nozzle.

2. The molding apparatus of claim 1 wherein said rod is pneumatically reciprocable.

3. The molding apparatus of claim 2 wherein:
said rod includes at least one pressure surface; and
said rod is reciprocable with a gas pressure at said pressure surface.

4. The molding apparatus of claim 3 wherein said rod includes an enlarged distal portion having a first pressure surface, and a proximal portion having a second pressure surface, said rod being reciprocable with a gas pressure supplied to either of said first and said second pressure surfaces.

5. The molding apparatus of claim 1 further comprising a water supply selectively connectable to said fluid passage in said nozzle.

6. The molding apparatus of claim 1 further comprising a fluid seal in said nozzle, said fluid seal comprising:
a compressible elastomeric member about said rod;
a sleeve having a sliding interface with said rod, an exterior of said sleeve abutting said elastomeric member;
wherein axial compression of said elastomeric member inwardly deforms said sleeve, creating a fluid seal at said interface.

7. The molding apparatus of claim 6 wherein said sleeve is formed from polytetrafluoroethylene.

8. A nozzle for an injection molding apparatus comprising:
a nozzle housing defining a fluid passage and an outlet;
a rod extending through said fluid passage and reciprocable therein to valve said outlet;
an annular seal in said housing, said seal comprising a compressible elastomeric member and a resilient sleeve positioned about said rod;
wherein compression of said elastomeric member deforms said sleeve, creating a fluid seal with said rod.

9. The nozzle of claim 8 wherein:
said sleeve includes a substantially frustoconical portion;
said elastomeric member abuts said frustoconical portion, wherein axial compression of said elastomeric member inwardly radially constricts said sleeve about said reciprocable member.

10. The nozzle of claim 8 wherein said compressible elastomeric member is an O-ring, compression of said member forming a fluid seal with said nozzle housing.

11. A process for pressure assisted injection molding in a molding apparatus having a mold cavity, the process comprising the steps of:
injecting a quantity of fluent plastic into the mold cavity;
injecting an incompressible fluid into the mold cavity via a hollow nozzle;
pressurizing a fluid supply line connectable to the nozzle with compressible fluid;
actuating a gas valve adjacent the nozzle to selectively connect the fluid supply line with the mold cavity via the hollow nozzle;
injecting pressurized fluid from the supply line into the mold cavity.

12. The process of claim 111 further comprising the steps of:
selectively connecting the mold cavity with a drain after injecting the pressurized fluid, thereby allowing at least a portion of the incompressible fluid to flow from the mold cavity.

13. The process of claim 11 further comprising the step of:
pneumatically actuating a rod reciprocable in the nozzle to selectively control fluid communications between the nozzle and the mold cavity.

14. A nozzle for a gas assisted injection molding apparatus having a mold cavity, the nozzle comprising:
a nozzle body having a fluid passage;
a rod reciprocable in the passage, the rod having a conical distal portion for valving fluid communications between said passage and the mold cavity; and
an actuator for reciprocating said rod, said rod being reciprocable with either of said actuator or a fluid pressure on said conical distal portion.

15. The nozzle of claim 14 further comprising:
a water inlet and a pressurized gas inlet defined by said nozzle body, said water and pressurized gas inlets fluidly connectable to said mold cavity via said fluid passage;
an actuatable gas valve at said gas inlet, actuation of said gas valve selectively supplying pressurized fluid to said fluid passage.

16. The nozzle of claim 14 wherein said rod includes a pressure surface opposite said enlarged distal portion, said valve member reciprocable with an adjustment of a gas pressure at said pressure surface.

17. The nozzle of claim 14 wherein said actuator is an electrical actuator.

18. The nozzle of claim 14 wherein said actuator is a ball screw drive actuator.

19. The nozzle of claim 16 further comprising:
a compressible elastomeric member about said pin;
an annular sleeve about said rod, an exterior of said sleeve abutting said elastomeric member;
wherein axial compression of said elastomeric member inwardly deforms said sleeve, creating a fluid seal with said rod.
